(19) United States
(12) Patent Application Publication
(10) Pub. No.: US 2002/0120915 A1
(43) Pub. Date: Aug. 29, 2002

(54) Combined scheduling and mapping of digital signal processing algorithms on a VLIW processor

(76) Inventors: Shoab A. Khan, Rawalpindi (PK); Mohammed Sohail Sadiq, Rawalpindi (PK)

Correspondence Address: O'MELVENY & MYERS LLP, 400 So. Hope Street, Los Angeles, CA, 90071-2899, US

(21) Appl. No.: 09/976,720

(22) Filed: Oct. 12, 2001

Related U.S. Application Data
(60) Provisional application No. 60/240,151, filed on Oct. 13, 2000.

(51) Int. Cl. G06F 9/44

(52) U.S. Cl. 717/100

(57) ABSTRACT

A method for scheduling computation operations on a very long instruction word processor to achieve an optimal iteration period for a cyclic algorithm uses a flow graph to aid in scheduling instructions. In the flow graph, each computation operation appears as a separate node, and the edges between nodes represent data dependencies. The flow graph is transformed into machine-readable data for use in an integer linear program. The machine-readable data expresses equations and constraints associated with the optimal iteration period of the algorithm implemented on a processor having a plurality of types of functional units. The equations and constraints comprise an objective function to be minimized, a set of operation precedent constraints, job completion constraints, iteration period constraints and functional unit constraints. The nature of the equations and constraints are modified based upon processor architecture. The minimum iteration period for completion of the computation operations, and the scheduling of nodal operations, is determined by computing an optimal solution to the integer linear program as a solution of its corresponding linear constraints. The computation operations are scheduled according to the optimal solution provided by the integer linear program.

### REFERENCE TO RELATED APPLICATION

The present patent application claims priority benefit of U.S. Provisional Application No. 60/240,151, filed Oct. 13, 2000, titled “COMBINED SCHEDULING AND MAPPING OF DIGITAL SIGNAL PROCESSING ALGORITHMS ON VLIW DSPS,” the content of which is hereby incorporated by reference in its entirety.

### FIELD OF THE INVENTION

This invention relates to the optimization of signal processing programs, and more particularly, to a process for the combined scheduling and mapping of fully deterministic digital signal processing algorithms on a processor.

### DESCRIPTION OF THE RELATED ART

Computational efficiency is critical to the effective execution of Digital Signal Processing (DSP) applications. Real-time DSP applications usually require processing large quantities of data in a short period of time. The DSP algorithms that comprise the DSP applications can be continuous and repetitive in nature, where operations are repeated in an iterative manner as samples are processed, and often possess a high degree of parallelism, where several separate operations can be executed concurrently.

Because digital signal processing algorithms often possess a high degree of parallelism, multiple processors may work in parallel to perform the computations. Consequently, DSP applications are implemented on DSP hardware systems having multiple Functional Units (FUs) capable of processing data simultaneously. Such hardware systems comprise processors with FUs on a single chip architecture, referred to as Very Long Instruction Word (VLIW) architecture; where one long instruction word specifies the instructions to be performed by each of the FUs in a machine cycle. The TMS320C6xx/TMS320C64x ('C6xx) family of DSPs from Texas Instruments® provides one example of a DSP processor with multiple functional units utilizing a VLIW architecture. The StarCore SC 140 by Motorola is another such example.

To optimize the execution of DSP applications, the DSP algorithms should be implemented in a manner that exploits the processor architecture by utilizing instruction-level parallelism. Developing this parallelism, however, is a tedious task. Conventionally, a complier is used to detect parallel operations in a program and automatically map them onto the processor architecture. While effective in some cases, compiled code often does not utilize the full parallelism of the processor architecture.

As an example, the 'C6xx DSP uses a RISC-like instruction set to aid the compiler with dependency checking. The compiler detects parallel operations in a program and attempts to schedule the instructions for optimal performance. In some special cases, the compiler is effective in producing parallel code. Nevertheless, code for complex algorithms, written in hand-coded assembly language, often outperforms compiler-generated code by a factor of 10-40. Writing parallel assembly language code by hand is a tedious and time consuming task, typically requiring many revisions of the code in order to detect and schedule the parallelism present in the algorithm.

To improve the efficiency of mapping and scheduling, while minimizing the effort required, various techniques, particularly compiler-based solutions, have been proposed. None of these techniques, however, optimally utilize instruction-level parallelism. It is therefore needed to have an improved method and system to schedule and map the operations of a DSP algorithm onto a parallel computing system.

### SUMMARY OF THE INVENTION

The present invention addresses these and other problems by providing a method for scheduling computation operations on a very long instruction word processor so as to have a substantially optimal iteration period for a cyclic algorithm.

One embodiment uses a flow graph wherein each computation operation appears as a separate node, and a plurality of edges represents data dependencies between the separate nodes. The scheduling and mapping problem is modeled on the basis of the DSP algorithm, and the processor architecture. The flow graph is transformed into machine-readable data for use in an integer linear program. The machine-readable data expresses equations and constraints associated with the optimal iteration period of the algorithm implemented on a processor having a plurality of types of functional units. The equations and constraints comprise an objective function to be minimized, a set of operation precedent constraints, job completion constraints, iteration period constraints and functional unit constraints. The nature of the equations and constraints are modified based upon processor architecture. The minimum iteration period for completion of the computation operations, and the scheduling of nodal operations, is determined by computing an optimal solution to the integer linear program as a solution of its corresponding linear constraints. The computation operations are scheduled and mapped according to the optimal solution provided by the integer linear program.

### BRIEF DESCRIPTION OF THE DRAWINGS

These and other features and advantages of the present invention will be appreciated, as they become better understood by reference to the following Detailed Description when considered in connection with the accompanying drawings, wherein:

FIG. 1 depicts a Fully Specified Flow Graph (FSFG) of a 2^{nd} order Infinite Impulse Response (IIR) filter;

FIG. 2 is a block diagram of the functional units of the 'C6xx DSP;

FIG. 3 depicts a FSFG of a 2^{nd} order IIR filter with memory access; and

FIG. 4 is a block diagram of the data path of a StarCore processor

### DETAILED DESCRIPTION OF THE INVENTION

The present invention is a method and system for mapping and scheduling algorithms on parallel processing units. The present invention will presently be described with reference to the aforementioned drawings. Where arrows are utilized in the drawings, it would be appreciated by one of ordinary skill in the art that the arrows represent the interconnection of elements and/or the communication of data between elements.

Defining the signal processing algorithm by using a fully specified flow graph (FSFG) decreases the development time of signal processing algorithms. A FSFG is defined by the 3-tuple <N,E,D> where N is a set of nodes that represent the atomic operations performed on the data, E is a set of directed edges that represent the flow of data between different operations, and D is a set of ideal delays.

The parameters characterizing an FSFG mapped onto multiple functional units include the following:

N the set of nodes

E the set of directed edges

D the set of ideal delays

P_{i/o} a set of paths from input node to output node

tᵢ a time that node iεN completes its execution

τ iteration period (time after which next iteration can be started)

dᵢ execution time of node iεN

n_{vw} a number of ideal delays on edge e(v, w)εE from node v to node w where (v,wεN)

D_{i/o} a throughput delay

Pᵣ a number of processors of type r in the VLIW

r a type of processor ε{adder, multiplier, register, etc.}

Other variables can be optionally incorporated into a FSFG, such as cpⱼₖ, a communication path between functional units j and k, cⱼₖ, a communication cost for communication path cpⱼₖ, and uⱼₖ, a maximum number of communications on communication path cpⱼₖ at any one instant.

FSFG graphs are normally cyclic, with data dependencies between iterations. The computational latency of node i is given by dᵢ, and tᵢ represents the time at which node i completes its execution. The nodes in the FSFG are atomic operations that are indivisible and depend on the computational capacity of the functional units. Atomic operations represent the smallest granularity of achievable parallelism.

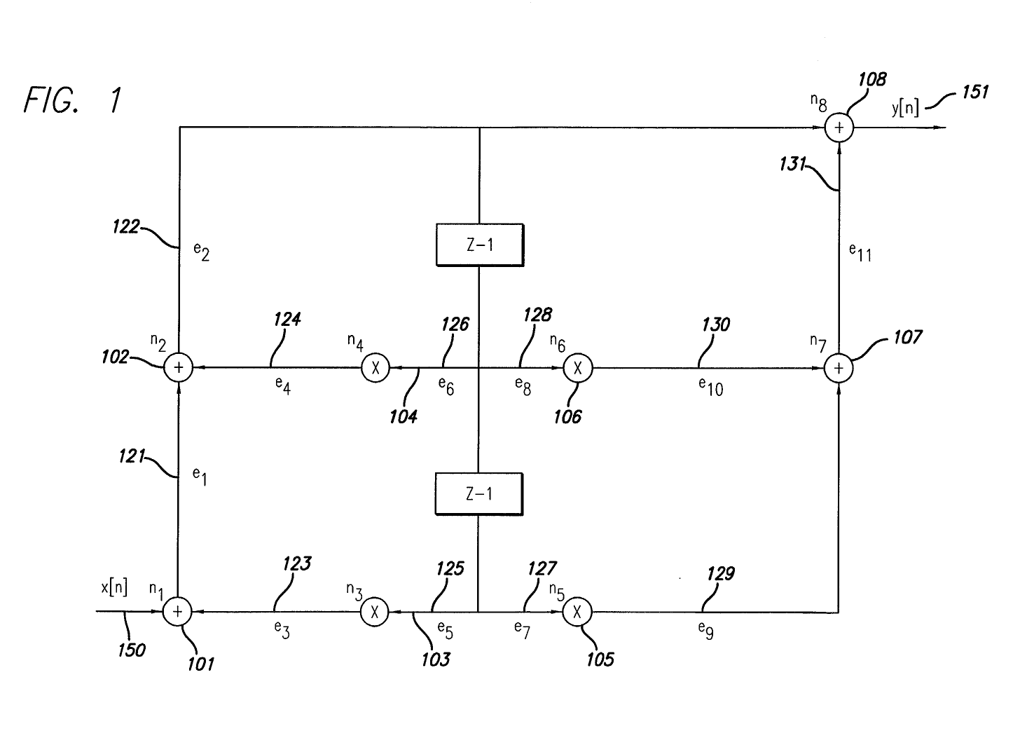

The FSFG of a 2^{nd} order IIR filter is shown in FIG. 1. The input 150 is shown as signal x[n], and the output 151 is shown by the signal y[n]. Nodes n₁ 101, n₂ 102, n₇ 107, and n₈ 108 perform addition operations, while nodes n₃ 103, n₄ 104, n₅ 105, and n₆ 106 perform multiply operations.

The edges of the graph represent data dependencies between the nodes. Where more than one operation depends on the output of a node, each dependency is represented as a separate edge. The separate edges are required for scheduling purposes. Node n₈ 108 depends from nodes n₂ 102 and n₇ 107, and the dependencies are represented by edges e₂ 122 and e₁₁ 131, respectively. Nodes n₃ 103, n₄ 104, n₅ 105, and n₆ 106 also depend from node n₂ 102, and the dependencies are represented by edges e₅ 125, e₆ 126, e₇ 127, and e₈ 128, respectively. Edges e₆ 126 and e₈ 128 represent dependencies from node n₂ 102 but with a delay, and edges e₅ 125 and e₇ 127 represent dependencies from node n₂ 102 with two delays. Edges e₁ 121, e₃ 123, and e₉ 129 represent dependencies from nodes n₁ 101, n₃ 103, and n₅ 105 to nodes n₂ 102, n₁ 101, and n₇ 107 respectively. Input signals a₀, a₁, b₀ and b₁ [collectively not shown] represent the coefficients of the IIR filter and are inputted into n₄ 104, n₃ 103, n₆ 106, and n₅ 105 respectively.

The FSFG is also useful to define the parameters and constraints for a Mixed Integer Program (MIP). A mixed integer programming approach for optimally scheduling and mapping of algorithms onto a processor eases the process of hand coding. Mixed Integer Programming is similar to Linear Programming (LP), where a system is modeled using a series of linear equations. Each equation represents a constraint on the system. In addition to the constraints, there is an objective function, where the goal is to minimize (or sometimes maximize) the result.

Mixed Integer Programming is useful when the feasible solutions have to be the equivalent of whole numbers or a binary decision. For example, assuming it is not feasible to schedule 1.2438 multiplication operations in a clock cycle, then the optimum number of multiplication operations must be 1 or 2. Simply rounding off values does not guarantee correct results, instead, Integer Programming must be used.

The inherent constraints of the DSP and the scheduling requirements of the FSFG provide a starting point for writing an efficient signal-processing algorithm. Through trial and error, a programmer may eventually create an optimal algorithm. Through the use of Integer Linear Programming (ILP) techniques to automate this long and difficult task, a programmer can greatly reduce development time. With ILP, the incorporated variables are limited to integer values while with MIP a portion of the variables can have integer values and a portion of the variables can have real values.

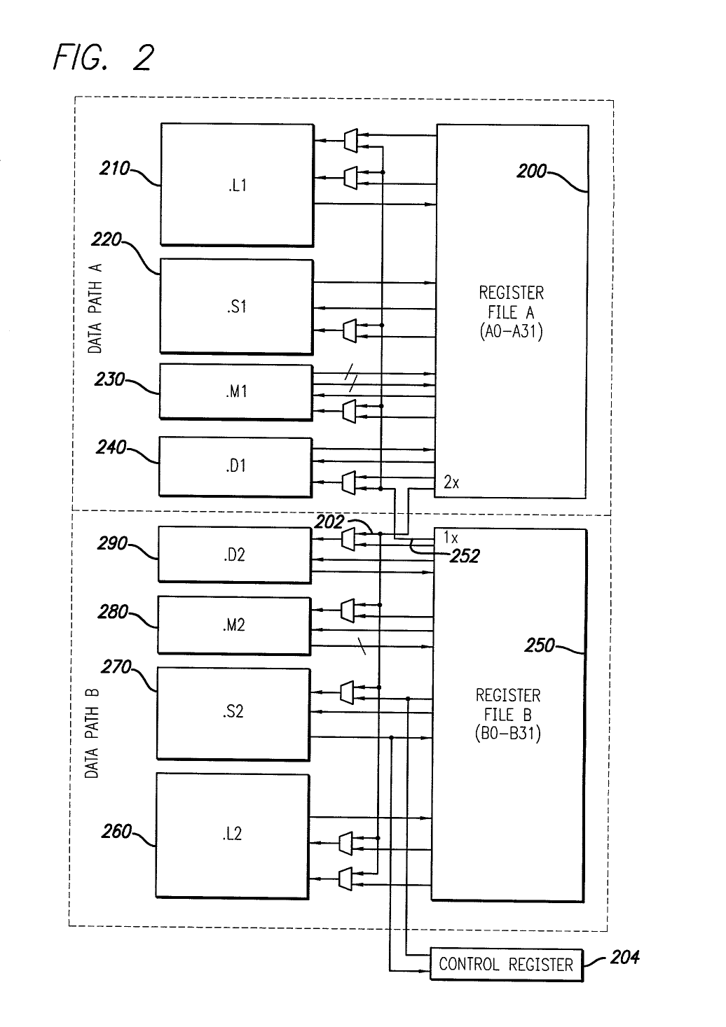

The scheduling of parallel instructions is driven largely by the architecture of the DSP. A simplified data path of the 'C6xx DSP is shown in FIG. 2. The 'C6xx has eight functional units divided into two groups, each group having four functional unit types, labeled .L1 210, .S1 220, .M1 230, and .D1 240, and .L2 260, .S2 270, .M2 280,. and D2 290. Each of the four unit types can perform different specialized operations, such as, arithmetic operations, byte shift operations, multiplication or compare operations, and address generation. Each group of four functional units is also associated with a register file 200, 250 containing 16, 32-bit registers, each. Each functional unit reads directly from and writes directly to the register file within its own group. Additionally, the two register files are connected to the functional units of the opposite side via unidirectional cross paths 202, 252. The 3 FU's on one side can access only one operand from the other side at a time. Both sides work independently. The only cross communication is via the cross paths, and these cannot be used to store a result on the register file of the other side. The 'C6xx also includes a control register 204 for handling memory access.

The multiple functional units of the 'C6xx DSP are controlled by the several basic instructions found in a single long instruction word. By carefully scheduling the parallel execution of independent basic instructions, a programmer can efficiently implement signal processing algorithms.

The code for a 'C6xx DSP must provide for the transfer of data from memory or registers between the two groups of functional units using the cross paths 202, 252. The two groups of functional units are connected by their register files 200, 250, so all communications between them must go through the registers. This requires modifying the FSFG to include storage of results into the registers as a node.

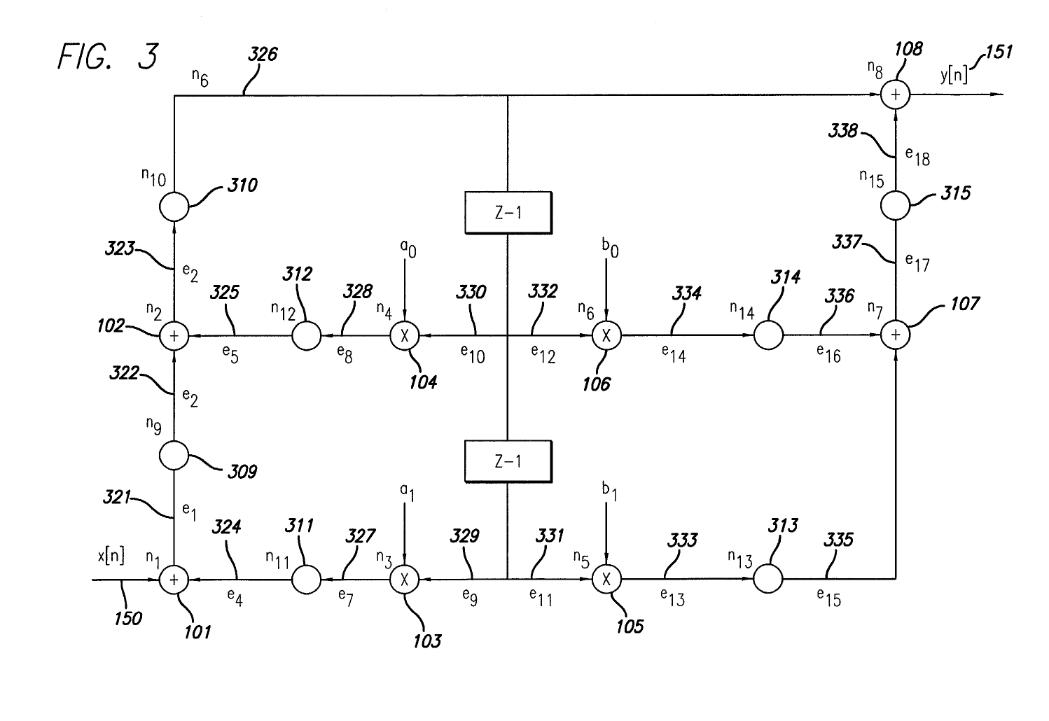

FIG. 3 shows a new FSFG of the 2^{nd} order IIR filter with memory nodes at the output of every original node. Edges e₁ 321, e₃ 323, e₇ 327, e₈ 328, e₁₃ 333, e₁₄ 334, and e₁₇ 337 provide data for memory nodes n₉ 309, n₁₀ 310, n₁₁ 311, n₁₂ 312, n₁₃ 313, n₁₄ 314, and n₁₅ 315, respectively. Edges e₁ 321, e₃ 323, e₇ 327, e₈ 328, e₁₃ 333, e₁₄ 334, and e₁₇ 337 represent dependencies from nodes n₁ 101, n₂ 102, n₃ 103, n₄ 104, n₅ 105, n₆ 106, and n₇ 107, respectively.

Node n₈ 108 depends from nodes n₁₀ 310 and n₁₅ 315, and the dependencies are represented by edges e₆ 326 and e₁₈ 338, respectively. Nodes n₃ 103, n₄ 104, n₅ 105, and n₆ 106 also depend from node n₁₀ 310, and the dependencies are represented by edges e₉ 329, e₁₀ 330, e₁₁ 331, and e₁₂ 332, respectively. Edges e₁₀ 330 and e₁₂ 332 represent dependencies from node n₁₀ 310 but with a delay, and edges e₉ 329 and e₁₁ 331 represent dependencies from node n₁₀ 310 with two delays. Edges e₂ 322, e₄ 324, and e₁₅ 335 represent dependencies from memory nodes n₉ 309, n₁₁ 311, and n₁₃ 313 to nodes n₂ 102, n₁ 101, and n₇ 107 respectively. Input signals a₀ 160, a₁ 161, b₀ 170 and b₁ 171 represent the coefficients of the IIR filter.

Signal processing algorithms typically run through repeated iterations of a computation process. Because of the cyclic nature of signal processing algorithms, optimizing the iteration period results in optimization of the entire algorithm. Ideally, the iteration period takes a single cycle to complete. This is usually not possible, however, because data dependencies prevent performing all the nodes at the same time. Additionally, the number of functional units on the 'C6xx DSP is limited, so a single iteration period may take several VLIW cycles to complete.

Minimization of the Iteration Period (τ) and the periodic throughput delay D_{i/o} provides the optimal schedule when given limited processing resources. The iteration period can be expressed by the equation

$${τ}_{j} = \{ \begin{matrix}1 & if j is the selected iteration period \\ 0 & otherwise\end{matrix}$$

While it is possible to have a range of iteration periods between lower and upper bounds, only a single iteration period can be deemed valid and true, namely have the value of 1.

The throughput delay D_{i/o} is given by the expression

$${D}_{t / o} = {\sum }_{p = 1}^{{P}_{r}} {\sum }_{t = 1}^{T} {x}_{( output ) pt} - {\sum }_{p = 1}^{{P}_{r}} {\sum }_{t = 1}^{T} {x}_{( input ) pt}$$

By weighting the iteration period by a factor of T. both the iteration period and the throughput delay can be optimized with a single equation. Using T ensures that the weighted iteration period is greater than the maximum possible throughput delay.

Even though the minimum iteration period is not known in advance, the programmer can often make a reasonable estimate of the expected value. Setting a lower bound bₗ and an upper bound bᵤ for possible iteration time periods reduces the computing time required to solve the minimization equation. The objective function is to optimize the iteration period and throughput delay by minimizing the expression

$$T {\sum }_{j = {b}_{l}}^{{b}_{u}} j {τ}_{j} + {\sum }_{p = 1}^{{P}_{r}} {\sum }_{t = 1}^{T} {x}_{( output ) pt} - {\sum }_{p = 1}^{{P}_{r}} {\sum }_{t = 1}^{T} {x}_{( input ) pt}$$

After specifying the objective function, integer linear programming also requires defining the constraints. Inputs to some nodes depend from outputs of other nodes, so not all the nodes in the FSFG can be processed in parallel. Constraints are used to define nodes that must be processed in sequential order. Given that node v precedes node w, the time at which node w is processed must be greater than the time at which node v is processed. Further, this difference in time must be greater than the difference between the computational throughput delay and the cost of ideal delays for a given iteration period. This concept is expressed by the equation

$${t}_{w} - {t}_{v} > {d}_{w} - {n}_{vw} {\sum }_{j = {b}_{l}}^{{b}_{u}} j {τ}_{j} , for e ( v , w ) ∈ E$$

$$where {t}_{i} = {\sum }_{t = 1}^{T} t {\sum }_{p = 1}^{{P}_{r}} {x}_{ipt}$$

This equation does not model the costs associated with memory and registers. The functional units can communicate by using the cross paths or store data in memory, and these communication costs must be factored into the operation precedence constraints. The communication costs are given by the expression

$${\sum }_{t = 1}^{T} {\sum }_{{p}_{2} = 1}^{{P}_{r}} {x}_{{i}_{2} {p}_{2} t} {\sum }_{{p}_{1} = 1}^{{P}_{r}} {c}_{{p}_{2} {p}_{1}} {x}_{{i}_{1} {p}_{1} t}$$

Combining these expressions, the operation precedence constraint is defined by the equation

$${\sum }_{t = 1}^{T} t {\sum }_{{p}_{2} = 1}^{{P}_{r}} {x}_{{i}_{2} {p}_{2} t} - {\sum }_{t = 1}^{T} t {\sum }_{{p}_{1} = 1}^{{P}_{r}} {x}_{{i}_{1} {p}_{1} t} - {d}_{{i}_{2}} + {n}_{{i}_{1} {i}_{2}} {\sum }_{j = {b}_{l}}^{{b}_{u}} j {τ}_{j} - {\sum }_{t = 1}^{T} {\sum }_{{p}_{2} = 1}^{{P}_{r}} {x}_{{i}_{2} {p}_{2} t} {\sum }_{{p}_{1} = 1}^{{P}_{r}} {c}_{{p}_{2} {p}_{1}} {x}_{{i}_{1} {p}_{1} t} > 0$$

The above expression is nonlinear and cannot be solved by existing MIP solvers. Therefore the Oral and Kettani transformation is applied to linearize the expression as follows:

$$Let {y}_{{i}_{2} {p}_{2} t} = {x}_{{i}_{2} {p}_{2} t} {\sum }_{{p}_{1} = 1}^{{P}_{r}} {c}_{{p}_{2} {p}_{1}} {x}_{{i}_{1} {p}_{1} t} such that$$

$${y}_{{i}_{2} {p}_{2} t} = \{ \begin{matrix} 0 & if {x}_{{i}_{2} {p}_{2} t} = 0 \\ {\sum }_{{p}_{1} = 1}^{{P}_{r}} {c}_{{p}_{2} {p}_{1}} {x}_{{i}_{1} {p}_{1} t} & if {x}_{{i}_{2} {p}_{2} t} = 1\end{matrix}$$

Replace the nonlinear yᵢ_{₂}ₚ_{₂}ₜ with a linear expression

$${\sum }_{{p}_{1} = 1}^{{P}_{r}} {c}_{{p}_{2} {p}_{1}} {x}_{{i}_{1} {p}_{1} t} - {b}_{{p}_{2}} ( 1 - {x}_{{i}_{2} {p}_{2} t} ) + {z}_{{i}_{2} {p}_{2} t}$$

$$where {b}_{{p}_{2}} = {{\sum }_{p}}_{1}^{{P}_{r}} {c}_{{p}_{2} {p}_{1}} then$$

$${\sum }_{t = 1}^{T} t {\sum }_{{p}_{2} = 1}^{{P}_{r}} {x}_{{i}_{2} {p}_{2} t} - {\sum }_{t = 1}^{T} t {\sum }_{{p}_{1} = 1}^{{P}_{r}} {x}_{{i}_{1} {p}_{1} t} - {d}_{{i}_{2}} + {n}_{{i}_{1} {i}_{2}} {\sum }_{j = lb}^{ub} j {τ}_{j} - {\sum }_{t = 1}^{T} {\sum }_{{p}_{2} = 1}^{{P}_{r}} \{ {\sum }_{{p}_{1} = 1}^{{P}_{r}} {c}_{{p}_{2} {p}_{1}} {x}_{{i}_{1} {p}_{1} t} + {b}_{{p}_{2}} ( 1 + {x}_{{i}_{2} {p}_{2} t} ) + {z}_{{i}_{2} {p}_{2} t} \} > 0$$

All nodes of the FSFG must be scheduled for processing a single time within each iteration period. This job completion constraint is shown by the expression

$${\sum }_{t = 1}^{T} {\sum }_{p = 1}^{{P}_{r}} {x}_{ipt} = 1 , for all nodes i = 1 , 2 , … , N$$

Only one iteration period is selected from the range of iteration periods. This iteration period constraint is shown by the expression

$${\sum }_{j = {b}_{l}}^{{b}_{u}} {τ}_{j} = 1$$

The iteration period is being minimized, so more than one time value can be assigned to the iteration period. The functional unit modulo constraint ensures that, at most, P_{fu} processors are used for each time classes. There are bᵤ−bₗ+1 sets of iteration period. To model this, each set must be specified to constrain the problem only if its iteration period is optimal.

A Functional Unit of type fu can do the operation of type fu because it represents the set of time classes for which an operation remains alive on a FU.

$${\sum }_{i ∈ {N}_{r}} {\sum }_{p = 1}^{{P}_{r}} {\sum }_{s ∈ {S}_{n}} {x}_{ips} < {P}_{fu} + M ( 1 - {τ}_{j} )$$

$$for t = 1 , 2 , … , {S}_{n} n = 0 , 1 , … , {b}_{l} - 1. {S}_{n} = \{ s \vert s mod {b}_{l} = n \}$$

$${\sum }_{i ∈ {N}_{r}} {\sum }_{p = 1}^{{P}_{r}} {\sum }_{s ∈ {S}_{n}} {x}_{ips} < {P}_{fu} + M ( 1 - {τ}_{j} )$$

$$for t = 1 , 2 , … , T n = 0 , 1 , … , {b}_{u} - 1 , {S}_{n} = \{ s \vert s mod {b}_{u} = n \}$$

M should be greater than P_{fu} so that an either-or-constraint condition is met.

N_{fu}=set of nodes mapped on the FU of type fu.

The DSP is limited to accessing a single operand for each of the two cross paths. This load constraint is shown by the expression

$${\sum }_{{i}_{2} , {i}_{1} ∈ L} {\sum }_{{p}_{2} = 1}^{{P}_{2}} {x}_{{i}_{2} {p}_{2} t} {\sum }_{{p}_{1} = 1}^{{P}_{1}} {x}_{{i}_{1} {p}_{1} t} \leq 1 for each time class t = 1 , … , T .$$

After linearization this quadratic expression becomes

$${\sum }_{{i}_{2} , {i}_{1} ∈ L} {\sum }_{{p}_{2} = 1}^{{P}_{2}} \{ {\sum }_{{p}_{1} = 1}^{{P}_{1}} {x}_{{i}_{1} {p}_{1} t} + {b}_{{p}_{2}} ( 1 - {x}_{{i}_{2} {p}_{2} t} ) + {z}_{{i}_{2} {p}_{1} {p}_{2} i} \} \leq 1$$

$$where {p}_{1} , {p}_{2} belong to different sides$$

The linearization process adds the following constraints to the MIP

$${z}_{{i}_{2} {p}_{2} t} + {\sum }_{{p}_{i} = 1}^{{P}_{1}} {x}_{{i}_{1} {p}_{1} t} - {b}_{{p}_{2}} ( 1 - {x}_{{i}_{2} {p}_{2} t} ) \geq 0$$

$${z}_{{i}_{2} {p}_{2} t} \geq 0 for all store edges and for all t = 1 , … , T , \\ {p}_{2} = 1 , … , {P}_{fu} and$$

$${z}_{{i}_{2} {p}_{1} {p}_{2} t} + {\sum }_{{p}_{1} = 1}^{{P}_{1}} {x}_{{i}_{1} {p}_{1} t} - {b}_{{p}_{2}} ( 1 - {x}_{{1}_{2} {p}_{2} t} ) \geq 0$$

$${z}_{{i}_{2} {p}_{1} {p}_{2} t} \geq 0 for all load edges$$

The performance of an operation by the FU p on a node i at time t is represented by the setting the value of xᵢₚₜ to 1. If no operation is performed with those parameters, the value is set to 0. This 0-1 constraint is shown by the expression

$${x}_{ipt} = \{ \begin{matrix}1 & node i is processed by FU p at time t \\ 0 & otherwise\end{matrix}$$

i=1,2, . . . , N

p=1,2, . . . , P_{fu}

t=1,2, . . . , T

N=Number of operation Nodes in the FSFG

P_{fu}=Number of FUs of Type fu in the VLIW

fᵤε={Adder, Multiplier, Register} etc.

T=Number of time classes considered.

The following example shows the results for a 2^{nd} order IIR filter shown in FIG. 3.

N=15 as shown in FSFG of FIG. 3.

Pₐ=the Number of Adders in the 'C6xx

Pₘ=the Number of Multipliers in the 'C6xx

Pr=the Number of Registers in the ° C.6xx

T=8 (approximate time to serially process the 8 nodes)

bᵤ=3 the upper bound estimate of the iteration period, which can be arbitrarily chosen, provided it is between the maximum number of nodes divided by the number of functional units and maximum nodes.

bₗ=2 the lower bound estimate of the iteration period (8 nodes with 4 functional units)

The objective function is given by the expression

$$Minimize : 8 {\sum }_{j = 2}^{3} {τ}_{j} + {\sum }_{p = 1}^{2} {\sum }_{t = 1}^{8} {x}_{8 pt} - {\sum }_{p = 1}^{2} {\sum }_{t = 1}^{8} {x}_{1 pt}$$

The precedence constraints are given by the expressions

$${\sum }_{t = 1}^{8} {t \sum }_{{p}_{2} = 1}^{2} {x}_{{i}_{2} {p}_{2} t} - {\sum }_{t = 1}^{8} {t \sum }_{{p}_{1} = 1}^{10} {x}_{{i}_{1} {p}_{1} t} - {d}_{{i}_{2}} + {n}_{{i}_{1} {i}_{2}} {\sum }_{j = 2}^{3} j {τ}_{j} > 0$$

for load edges {2, 4, 5, 6, 9, 10, 11, 12, 15, 16, 18}

$$- {\sum }_{t = 1}^{8} t {\sum }_{{p}_{2} = 1}^{2} {x}_{{i}_{2} {p}_{2} t} + {\sum }_{t = 1}^{8} t {\sum }_{{p}_{1} = 1}^{5} {x}_{{i}_{1} {p}_{1} t} + {n}_{{i}_{1} {i}_{2}} {\sum }_{j = 2}^{3} j {τ}_{j} \\ - {\sum }_{t = 1}^{T} {\sum }_{{p}_{2} = 1}^{2} \{ {\sum }_{{p}_{1} = 1}^{5} {x}_{{i}_{1} {p}_{1} t} + 5 ( 1 - {x}_{{i}_{2} {p}_{2} t} ) + {z}_{{i}_{2} {p}_{2} t} \} > 0$$

for store edges {1,3,7,8,13,14,17}

The job completion constraint is given by the expression

$${\sum }_{t = 1}^{8} {\sum }_{p = 1}^{{P}_{r}} {x}_{ipt} = 1 , for all nodes i = 1 , 2 , … , 15$$

The iteration period constraint is given by the expression

$${\sum }_{j = 2}^{3} {IP}_{j} = 1$$

The processor constraints are given by the expressions

$${\sum }_{i ϵ {N}_{r}} {\sum }_{p = 1}^{2} {\sum }_{s ϵ {S}_{n}} {x}_{ips} < {P}_{fu} + ( {P}_{fu} + 1 ) ( 1 - {τ}_{2} )$$

for S₀={1,3,5,7} S₁={2,4,6,8}

Nₐ{1,2,7,8} additions

Nₘ={3,4,5,6} Multiplications

Nᵣ={9,10,11,12,13,14} load/store

$${\sum }_{i ϵ {N}_{r}} {\sum }_{p = 1}^{2} {\sum }_{s ϵ {S}_{n}} {x}_{ips} < {P}_{fu} + ( {P}_{fu} + 1 ) ( 1 - {τ}_{3} )$$

for S₀={1,4,7}, S₁={2,5,8} S₂={3,6}

Nₐ={1,2,7,8} additions

Nₘ={3,4,5,6} Multiplications

Nᵣ={9,10,11,12,13,14} load/store

The load constraints are given by the expressions

$${\sum }_{{t}_{2} , {t}_{1} ε L} {\sum }_{{p}_{2} = 1}^{{P}_{2}} \{ {\sum }_{{p}_{1} = 1}^{{P}_{1}} {x}_{{i}_{1} {p}_{1} t} + {b}_{{p}_{2}} ( 1 - {x}_{{t}_{2} {p}_{2} t} ) + {z}_{{t}_{2} {t}_{1} {p}_{2} t} \} \leq 1$$

where p₁, p₂ belongs to different sides

The linearization process adds the following constraints to the MIP

$${z}_{{i}_{2} {p}_{2} t} + {\sum }_{{p}_{1} = 1}^{{P}_{1}} {x}_{{i}_{1} {p}_{1} t} - {b}_{{p}_{2}} ( 1 - {x}_{{i}_{2} {p}_{2} t} ) \geq 0$$

and zᵢ_{₂}ₚ_{₂}ₜ≧0 for all store edges {1,3,7, 8,13,14,17}, for all FUs and t=1,2, . . . , 8

$${z}_{{i}_{2} {i}_{1} {p}_{2} t} + {\sum }_{{p}_{1} = 1}^{{P}_{1}} {x}_{{i}_{1} {p}_{1} t} - {b}_{{p}_{2}} ( 1 - {x}_{{i}_{2} {p}_{2} t} ) \geq 0$$

and zᵢ_{₂}ᵢ_{₁}ₚ_{₂}ₜ≧0 for edges {2,4,5,6,15,16,18} for all FUs and t=1,2, . . . , 8

These equations are representative of equation sets which, when taken individually, can be solved using any known commercially available Integer Program solver operating on a computer having a central processing unit and memory. One of ordinary skill in the art would appreciate that, with the equations given above, equation sets can be derived that act as inputs to commercially available IP solvers and that results in outputs which detail a combined schedule and map of the algorithm onto the processor architecture.

The results of the process are shown in Table 1. The optimal iteration period is calculated to be 3, with the nodes scheduled as shown in Table 1. Time slots T1, T2, and T3 represent the three periods and the nodes are listed thereunder. It should be noted that node 8 from the previous iteration (the previous iteration is represented by the −1 superscript notation) is processed at the same time as nodes 3 and 5 from the following iteration. The far left hand column represents the functional units performing the iterated functions. Based on this, the DSP algorithm can readily be programmed.

TABLE 1
Combined Schedule for 2^{nd} Order IIR Filter for C6X

| | T1 | T2 | T3 |
|---|---|---|---|
| .M1 | 3¹ | 4¹ | |
| .M2 | 5¹ | 6¹ | |
| .L1 | | 1¹ | 2¹ |
| .L2 | 8⁻¹ | | 7¹ |

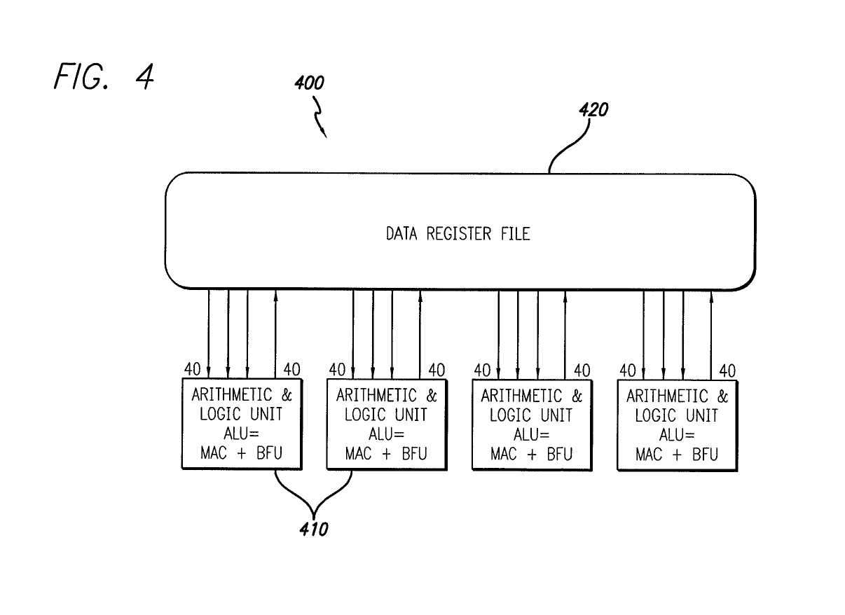

In a second embodiment, the invention is used to schedule and map a digital signal processing algorithm onto a StarCore SC 140 VLIW processor. The scheduling of parallel instructions is, as aforementioned, directed by the architecture of the DSP. As shown in FIG. 4, the simplified data path 400 of the StarCore processor has four FUs 410 and a 40-bit register file 420, which has sixteen registers [not shown individually]. All the FUs 410 are same, containing an ALU with a MAC and a bit operation unit. Thus, any operation can be assigned to any FU 410. This type of architecture is homogeneous and presents less scheduling constraints.

As previously discussed, in the scheduling process the iteration period and the periodic throughput delay must be minimized. In this embodiment, however, cross-path communication is not an issue, because of a different architecture relative to the previously examined processor. As such, the equations and constraints differ from the previously discussed exemplary application.

$${x}_{it} = \{ \begin{matrix}1 & node i is scheduled at time t \\ 0 & otherwise\end{matrix} i = 1 , 2 , … , N , t = 1 , 2 , … , T$$

N=Number of operation nodes in the FSFG,

T=Number of time classes considered

The necessary objective function to be minimized is

$$T {\sum }_{j = {b}_{l}}^{{b}_{u}} j {τ}_{j} + {\sum }_{t = 1}^{T} {x}_{ot} - {\sum }_{t = 1}^{T} {x}_{it}$$

where o=output node and i=input node

Precedence constraints are determined by modeling processor behavior. In this case, where node i₁ precedes node i₂, a precedence constraint is established, shown as

$${\sum }_{t = 1}^{T} {tx}_{{i}_{2} t} - {\sum }_{t = 1}^{T} {tx}_{{i}_{1} t} - {d}_{{i}_{2}} + {n}_{{i}_{1} {i}_{2}} {\sum }_{j = {b}_{l}}^{{b}_{u}} j {τ}_{j} > 0$$

for all edges e(i₁→i₂)εE where node i₁ must be scheduled before node i₂. The variables bₗ and bᵤ represent the lower and upper bounds of iteration period, τ and nᵢ_{₁}ᵢ_{₂} is the number of ideal delays on Edge e(i₁→i₂)εE.

The job completion constraints are set by the requirement that all nodes must be scheduled as:

$${\sum }_{t = 1}^{T} {x}_{it} = 1 , for all nodes i = 1 , 2 , … , N$$

Since only one iteration period is to be selected out of a range of iteration periods, the iteration period equation is:

$${\sum }_{j = {b}_{l}}^{{b}_{u}} {τ}_{j} = 1$$

As previously noted, the processor being used has 4 identical FUs. Therefore, at any given point in time, each of the FUs can be concurrently scheduled.

$${\sum }_{s ϵ {S}_{n}} {x}_{is} < 4 + M ( 1 - {τ}_{j} )$$

for i=1,2, . . . , N n=0,1, . . . , bᵤ−1, Sₙ=={s|s mod bᵤ=n}

M should be greater than 4 so that either-or-constraint condition is met.

N=set of nodes mapped on the FU.

xᵢₜε{0,1 for all i=1,2, . . . , N, and t=1,2, . . . , T

As a practical example, where a 5^{th} order digital filter needs to be mapped onto the StarCore processor, a FSFG is generated, with nodes and dependencies defined. Once complete, representative expressions and constraints are determined. In this case:

i=1,2, . . . ,26, t=1,2, . . . , 20

The objective function is given by the expression:

$$20 {\sum }_{j = 10}^{15} j {τ}_{j} + {\sum }_{t = 1}^{20} {x}_{34 t} - {\sum }_{t = 1}^{20} {x}_{1 t}$$

Operation Precedence Constraints are given by the equation:

$${\sum }_{t = 1}^{20} {tx}_{{1}_{2} t} - {\sum }_{t = 1}^{20} {tx}_{{i}_{1} t} - {d}_{{i}_{2}} + {n}_{{i}_{1} {i}_{2}} {\sum }_{j = 10}^{20} {x}_{1 t}$$

Job completion constraints are given by the expression:

$${\sum }_{t = 1}^{20} {x}_{it} = 1 , for all nodes i = 1 , 2 , … , 26$$

Iteration period constraints are given by the expression:

$${\sum }_{j = 10}^{15} {τ}_{j} = 1$$

FU constraints are given by the expression:

$${\sum }_{s ϵ {S}_{n}} {x}_{is} < 4 + 5 ( 1 - {τ}_{j} )$$

for i=1,2, . . . , 26 n=0,1, . . . , bₗ−1.Sₙ={s|s mod bₗ=n}

0-1 Constraints are given by the expression:

xᵢₜε{0,1 for all i=1,2, . . . , 26, and t=1,2, . . . , 20

The expressions can be solved with any known, commercially available Integer Program solver. One of ordinary skill in the art would appreciate that, with the equations given above, equation sets can be derived that act as inputs to commercially available IP solvers and that results in outputs which detail a combined schedule and map of the algorithm onto the processor architecture.

The resulting schedule of 5^{th} order digital wave filter is shown in Table 2. The optimal iteration period is calculated to be 10, with the nodes scheduled as shown in Table 2. Time slots T1 through T10 represent the ten periods and the nodes are listed thereunder. It should be noted that nodes 24, 25, and 11 from the previous iteration (the previous iteration is represented by the −1 superscript notation) is processed at the same time as node 2 from the following iteration. The far left hand column represents the functional units performing the iterated functions. Based on this, the DSP algorithm can readily be programmed.

TABLE 2
Optimal Schedule of 5th order digital wave filter on StarCore

| | T1 | T2 | T3 | T4 | T5 | T6 | T7 | T8 | T9 | T10 |
|---|---|---|---|---|---|---|---|---|---|---|
| DALU1 | 2 | 6 | 13 | 14 | 12 | 7 | 20 | 21 | 22 | 23 |
| DALU2 | 24⁻¹ | 19 | | | 15 | 17 | 5 | 26 | 1 | 3 |
| DALU3 | 25⁻¹ | | | | | 18 | | 8 | 9 | 4 |
| DALU4 | 11⁻¹ | | | | | | | | 16 | 10 |

The foregoing description of a preferred implementation has been presented by way of example only, and should not be read in a limiting sense. Although this invention has been described in terms of certain preferred embodiments, namely in terms of two specific processor types, other embodiments that are apparent to those of ordinary skill in the art, including embodiments which do not provide all of the benefits and features set forth herein, are also within the scope of this invention.

What is claimed is:

1. A method for scheduling computation operations on a very long instruction word processor so as to have an optimal iteration period for a cyclic algorithm comprising of a plurality of computation operations, the method comprising the steps of:
preparing for said algorithm a flow graph wherein each computation operation appears as a separate node, and a plurality of edges represents data dependencies between the separate nodes,
transforming the flow graph into machine-readable data for use in an integer linear program, wherein the data expresses equations and constraints associated with the optimal iteration period of the algorithm implemented on a processor having a plurality of types of functional units,
determining a minimum iteration period for completion of the computation operations by computing an optimal solution to the integer linear program as a solution of its corresponding linear constraints, and
scheduling the computation operations according to the optimal solution provided by the integer linear program.

2. The method of claim 1, wherein the minimum iteration period is derived by minimizing an objective function in relation to a plurality of operation precedent constraints, job completion constraints, iteration period constraints and functional unit constraints.
